(19) United States
(12) Patent Application Publication
(10) Pub. No.: US 2020/0193263 A1
(43) Pub. Date: Jun. 18, 2020

(54) ARTIFICIAL INTELLIGENCE (AI) ENHANCED AUTOMATED WORKFLOW, COLLABORATION AND KNOWLEDGE MANAGEMENT SYSTEM

(71) Applicant: Andrew T. Pham, Modesto, CA (US)

(72) Inventor: Andrew T. Pham, Modesto, CA (US)

(21) Appl. No.: 16/710,703

(22) Filed: Dec. 11, 2019

Related U.S. Application Data
(60) Provisional application No. 62/777,925, filed on Dec. 11, 2018.

(51) Int. Cl. G06N 3/00; G06F 16/29; G06F 16/93; G06F 16/951; H04L 12/24; G06F 3/0486; G06F 40/166; G06F 40/197

(52) U.S. Cl. CPC G06N 3/004; G06F 16/29; G06F 16/93; G06F 16/951; G06F 40/197; G06F 3/0486; H04L 41/22; G06F 40/166; H04L 41/14

(57) ABSTRACT

A collaboration and knowledge management system platform that includes features that simplify individual and collective tasks. The system utilizes communication tools and automation to speed up business processes. Immediate and productive collaboration is achieved as the system documents all interactions, captures notes, and allows users to search and share them for better collaboration and future reference. The system also functions as an innovation management platform. With it, entities can work on ideas, push forward transformation, and streamline the development of new ideas while being able to protect intellectual property.

### CROSS-REFERENCE TO RELATED APPLICATION

This application claims priority to, and the benefit of, provisional patent application Ser. No. 62/777,925, filed Dec. 11, 2018 and entitled “ARTIFICIAL INTELLIGENCE (AI) ENHANCED AUTOMATED WORKFLOW, COLLABORATION AND KNOWLEDGE MANAGEMENT SYSTEM,” the disclosure of which is incorporated herein by reference in its entirety.

### BACKGROUND

In recent surveys, most senior executives believe innovation is imperative for company growth and value creation, however they are uncertain what steps they can take to help make their company be more innovative. While most agree innovation is a driver of economic growth, few agree on which tactics to implement to cultivate a more innovative company. This is a major obstacle of innovation—when companies mistake tactics for strategy. Innovation is complex and unique to every company, dependent on the specific business vision, goals, and challenges. Implementing innovation tactics without an overarching philosophy, or innovation system is the primary reason why companies fail to innovate.

Without an innovation system in place, any efforts towards implementing innovative process improvements (such as ideology, tools, workflows, processes, software) can become a grab barrel of scattered “best practices,” such as employee crowdsourcing, collaborating with customers, open innovation, and more. While on their own, these practices are fine—it's when they're implemented within the organization without a coherent innovation system that companies run into problems. Even worse, without proper legal guidance, these scattershot programs may place company intellectual property at great peril. Thus, the innovation strategy must be compatible with the overall business objective, managed with a repeatable process and sound legal counsel. To think strategically, a company must be able to model the future. That is what it means to be innovative—innovation is creating the future. A major barrier to innovation is the proliferation of apps at the one extreme and over-reliance on a single “innovation system” at the other extreme.

In addition, there is a positive correlation between collaboration and innovation. Collaboration increases the chances of novel combinations of ideas and may result in a gifted product or process. Collaboration increases the chances of novel combinations of ideas and may result in a gifted product or process. As well, with collaboration one inventor may have a half idea, but when combined with another inventor's half idea forms a complete and innovative idea. As teams collaborate faster, innovation can be accelerated. Despite the plethora of new so-called team productivity and collaboration tools, a working collaboration and innovation process has been an evasive holy grail of organizations.

As such, there is a need for a platform that enhances collaboration and innovation to create an engaged workforce. The platform should foster the following components of a highly engaged workforce: Align efforts with strategy, empower the employee, promote and encourage working with colleagues, guide employees on path of growth and development, and provide support and recognition. By instituting an environment that supports innovative thinking, companies not only align their workforce with the overall vision and strategy, increasing productivity and employee energy, they cultivate the positive corollaries of less stressed and increasingly more engaged employees.

### SUMMARY

Systems, methods and software for aggregating and publishing innovations. In particular, users of this system may submit patent disclosures on various topics or technology areas. The system may then route the idea submissions through the patenting process to relatively rapidly develop a large patent portfolio. In some instances, the submissions may be published to be made accessible by others as part of a first to publish infrastructure. Further, the system may provide back end support for innovation cultivation and harvesting, innovation road mapping and brainstorming, and collaboration.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example high-level overview of the subject matter of the present disclosure;

FIG. 2 illustrates an example user interface to browse through and join a Space in the environment of FIG. 1;

FIG. 3 illustrates another user interface displaying activities within a Space;

FIG. 4 illustrates a user interface to explore a Space and its contents;

FIG. 5 illustrates a user interface displaying Boards within the environment of FIG. 1;

FIG. 6 illustrates a Discover feature of the present disclosure;

FIG. 7 illustrates an example of filtering in the user interface of FIG. 6;

FIG. 8 illustrates an example map in accordance the present disclosure;

FIG. 9 illustrates an example user interfaces showing a posting of a new idea;

FIG. 10 illustrates an example user interface showing a Notebook in accordance with the present disclosure;

FIGS. 11-12 illustrate an example automation tools in accordance with the present disclosure;

FIG. 13 illustrates an example user interface showing online document collaboration in accordance with the present disclosure; and

FIG. 14 illustrates an example computing environment associated with the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While specific implementations will be described below, it will become evident to those skilled in the art that the implementations are not limited thereto.

Introduction and Overview

Company workflows and processes refer to internal value creation processes. In other words, they include the steps teams take to complete work. Processes are not completed by individuals, but rather they are completed by multiple participants; not only within departments, but between departments. For example, consider how a company's press releases are drafted, reviewed, edited, reviewed again, requested approval, kicked-back for further edits. This is a typical workflow for a single press release moves through various departments, such as Engineering, Product Management, Content Marketing, PR Marketing, Executive, and Legal until it receives the final executive approval for distribution. Drafting the press release through final press release distribution is a workflow process requiring multiple participants. This process requires a tremendous amount of teamwork and is currently managed by emails; however the press release workflow is an example of teamwork that can be automated by the system of the present disclosure. In addition to company workflows, innovation may be the single most important element to a company's success, particularly during this age of disruption. An innovation workplace is one that embodies a cultural willingness to think creatively so all team members feel free to contribute ideas.

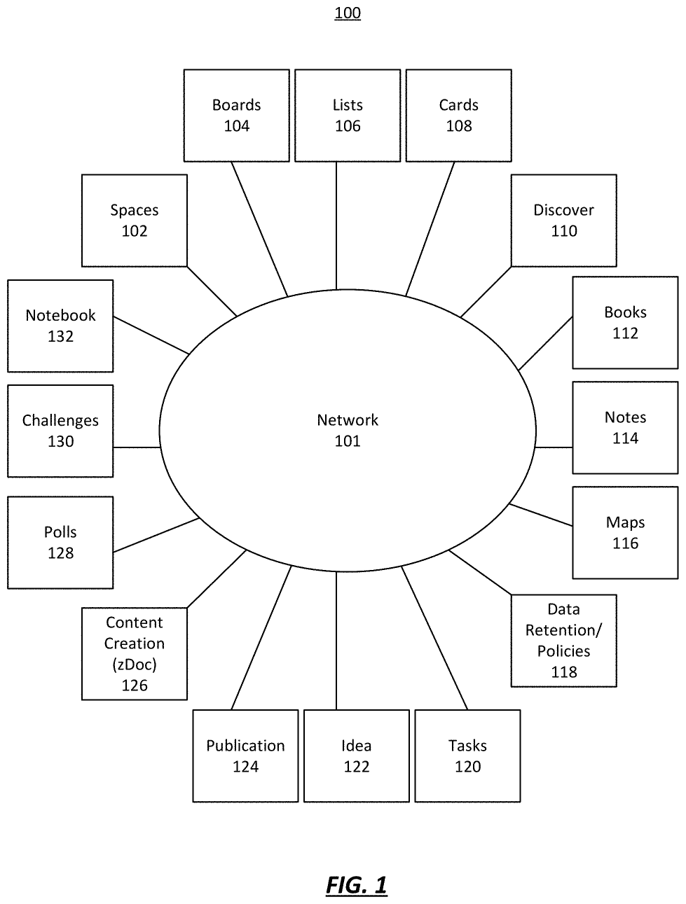

With reference to FIG. 1, the collaboration and knowledge management system 100 of the present disclosure aims to accelerate innovation, enhance collaboration, and foster continuous improvement through a suite of tools designed to improve team communications and dynamics (shown as reference number 104-132). The collaboration and knowledge management system 100 allows a user to create a private or public collaboration network 101 to which a user can add or invite a own team members.

Using the collaboration and knowledge management system 100, Spaces 102 can be created that link members of a network 101 with the same interests. Spaces 102 are central to the collaboration and knowledge management system 100. Within a Space 102, a user can chat and collaborate with network members belonging to the Space. There are three types of Spaces 102:
Network-wide—a space open to all network members;
Open—a space open to all network members as well as Guest and Restricted accounts; and
Private—an invitation from a administrator is required to join this unlisted space (in contrast to Network-wide and Open, which can be seen by network members). Content shared to a Private space can only be viewed by its members.

Spaces 102 may include two areas. The first is a “channel” where all the interactions in a Space occur. A user can post a message or share an update, upload a file from a desktop or the cloud, create a poll, assign a task, and send, copy, and forward an email to members of the Space. The second is “explore” where a user can search content, e.g. ideas, publications, polls, boards, challenges, and inventions, introduced to the Space. From a Space's Explore area, a user can search for content, e.g. ideas, publications, polls, boards, challenges, and inventions, introduced to the Space. From here, a user can also create a poll, post an idea, upload a document, publish an article, and post a challenge.

Network-wide spaces 102 are ideal for sharing company-wide information while Private spaces 102 are ideal if a user want to limit access to specific teams within a organization, since only members can view and act on available content in this type of space.

The collaboration and knowledge management system provides organizations and teams with secure and private Spaces 102 that maintain confidentiality and privacy. When creating a Space 102, a user is given the option to create either a Private or a Network-wide space. Private spaces 102 are ideal if a user want to limit access to specific teams within an organization, since only members can view and act on available content in this type of space while Network-wide spaces 102 are ideal for sharing company-wide information.

An Open Space is a Space 102 that has been upgraded to include Guest and Restricted Members. Open Spaces 102 can be set to Public so customers and clients can leave feedback and comments within the Space. The open information-sharing on Open spaces 102 helps provide teams with valuable information. Open Spaces 102 may be used to brainstorm new ideas, solutions, and technology from anyone and everyone; allow co-creation with key customers, clients, partners, or associate; as a feedback tool for customers and clients; engage customers through a Help Center Space to answer questions and provide instructions Collect reviews and ratings for a product or service to further enhance and improve it; promote a business through smart social networking where everyone is engaged and interested in a products and services; and let the media and public know what a user is doing.

Thus, a Space 102 is a collaboration sandbox. Spaces 102 are areas where a user can connect, innovate, imagine, and collaborate with other team members, allowing a ideas and those of other members to flourish. To Show Activities in a Space 102, an activity tab shows a history of the activity on the Space 102 including content conversations and social activities such as Pins and Shares. To show existing content in a Space 102, an About tab falls under the Space Name. About reveals all the Space's stats. This is the default view for users who may not be a member of a Space 102. Information found on this tab can help users decide if this Space is a fit for them. This first tab also contains the Insights Tab which provide analytics for the Space.

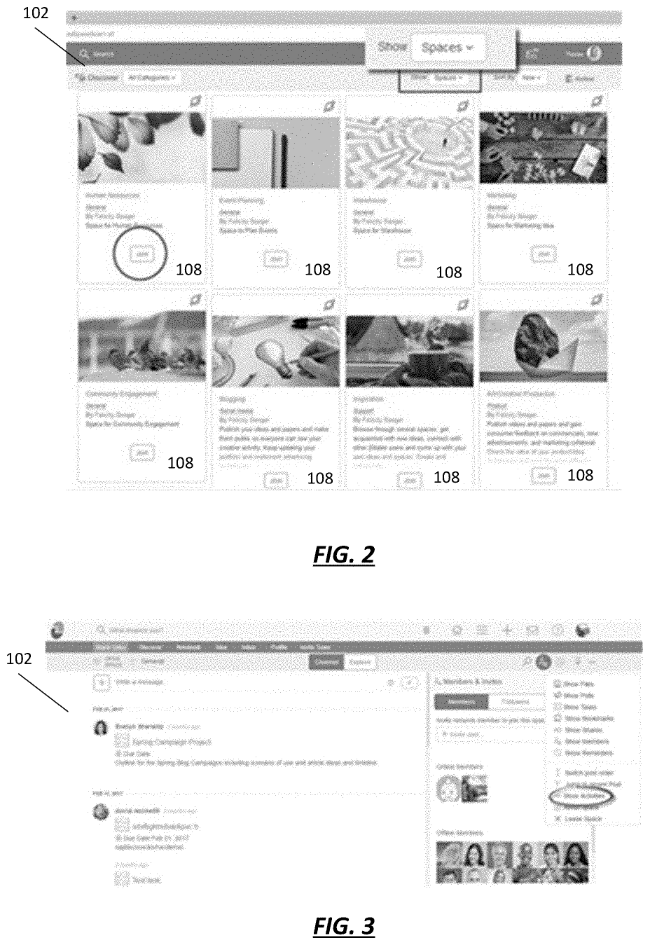

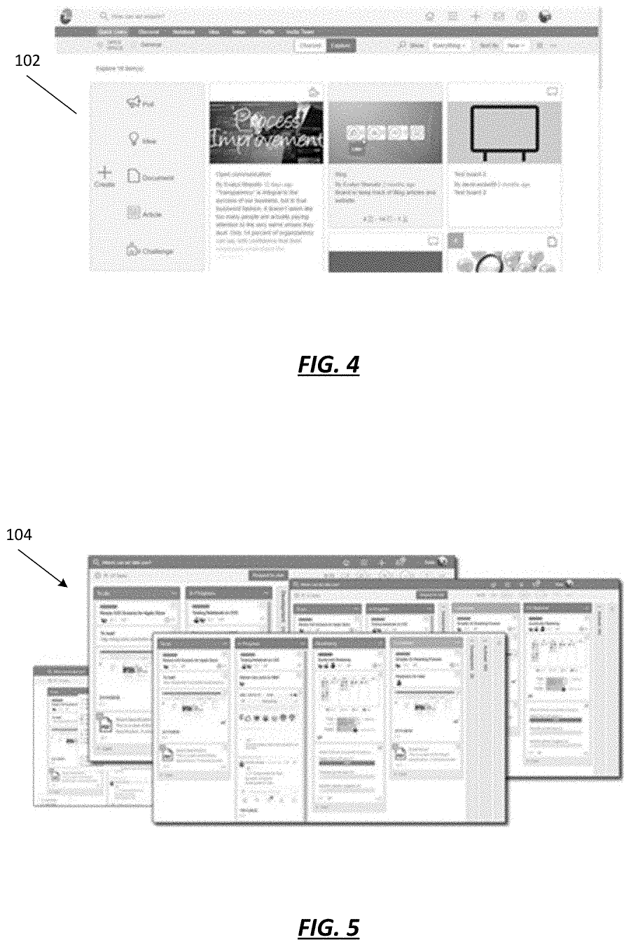

With reference to FIG. 2, to browse through and join Spaces 102 on a Network 101, a Discover option 110 from the top menu may be used. A user may join a Space 102 by clicking a Join option. As shown in FIG. 3, to view all activities within a Space 102, e.g. likes, comments, posts, and bookmarks, among others, the More options icon may be clicked to Show Activities to open a sidebar showing all the activities within the space. Click an activity to learn more about it. FIG. 4 shows a user interface to explore a Space 102 and its contents. From the Explore area, a user can search for content, e.g. ideas, publications, polls, boards, challenges, and inventions, introduced to the Space 102. A user can also create a poll, post an idea, upload a document, publish an article, and post a challenge on the Explore area. When a user mouses over a card 108 (when a user is on Card view) or an item (when a user is on List view) on the Explore area, a user can see more options like Like, Follow, Share, and Bookmark.

When exploring a Space 102, by default, it is shown in Card view of FIG. 2, which shows larger images of each content type and allows a user to see options like follow or like by hovering a mouse over the image. A list view shows a user created content in a list format with similar mouse over interactions.

As noted above, each Space 102 has Channel and Explore areas. The Channel area contains all the posts and updates on the Space while the Explore area is where a user search for content, e.g. ideas, publications, polls, boards, challenges, and inventions, introduced to the Space 102. From a Space's Explore area, a user can search for content, e.g. ideas, publications, polls, boards, challenges, and inventions, introduced to the Space 102. From here, a user can also create a poll, post an idea, upload a document, publish an article, and post a challenge. Members may be invited to a Space 102 to actively collaborate.

Mentions in a Space 102 using may be made using “@” followed by a person or group handle to send them an alert. Depending on their account settings, users mentioned in an alert may receive an in-app notification or email. A “!” followed by the title of the content to may be used to reference the content. Users can click on the referenced content to jump to it immediately. A “#” followed by a word or group of words, users can link any other conversations using the same Hashtag together. Clicking a hashtag will automatically search a private network for other conversations using the same hashtag.

Boards 104 are another feature of the collaboration and knowledge management system 100. From within a Space 102, Boards 104 can be created that revolve around topics of common interest to the Space 102's members. Boards 104 can represent a number of different things within a network. Boards 104 may enhance a challenge, manage a project, evaluate ideas, create workflows, or as a means to further develop anything on a network.

FIG. 5 shows example Boards 104 which represent a number of different things within a private network. Boards 104 to enhance a challenge, manage a project, evaluate ideas, create workflows, or as a means to further help develop anything on a network. Boards 104 contain Lists 106 with Cards 108 that represent people or any created content on a private network. Lists are basic steps within Boards. Members of a Board 104 move Cards 108 through lists according to a workflow that makes sense for their network. Board templates provide quick access to predefined workflows and lists based on high-value team processes. Templates can be used to jump-start a Board.

Lists 106 allow a user to divide a board into different categories that are either time- or event-based. Typically, a list represents the stage of progress (“to-do”, “in progress”, and “done”) within a project. Lists 106 set up different buckets to organize a tasks, notes, or content. Lists are made up of cards, or the Notes 114, Tasks 120, and other content that make up a specific stage of a project. Lists 106 can be moved—drag-and-drop is the more exact term—anywhere on a Board 102. A user can move cards in a list to another Board 102, essentially replicating the activities on that List in another project.

Cards 108 are the building blocks on Boards 102. If each List 106 on a Board represents a specific phase of a project, then Cards 108 represent specific elements within a project (a new feature, a software bug, research note, an idea, or paper). A user can attach images and files, make comments, and change colored labels on any card. A user can move or copy cards 108 between Lists 106 to show progress, and automatically move or copy them over to other Lists and Boards using bots (e.g., automated operations). A user can also choose to enable a compact view for all Cards 108 on the Board 102. The compact view shortens the information displayed on a card 108 to allow viewing of more Cards 108 consecutively.

There may be three types of cards 108: Notes 114, which are used to communicate non-time-sensitive information; Tasks 120 which are basically the same as Notes 114, except that a user have the option to assign the card to multiple people and include a Due Date; and any type of content, including People and Spaces 102, available on a network. Use the Search to narrow the content down to specific types, or click the suggested content to include on the card.

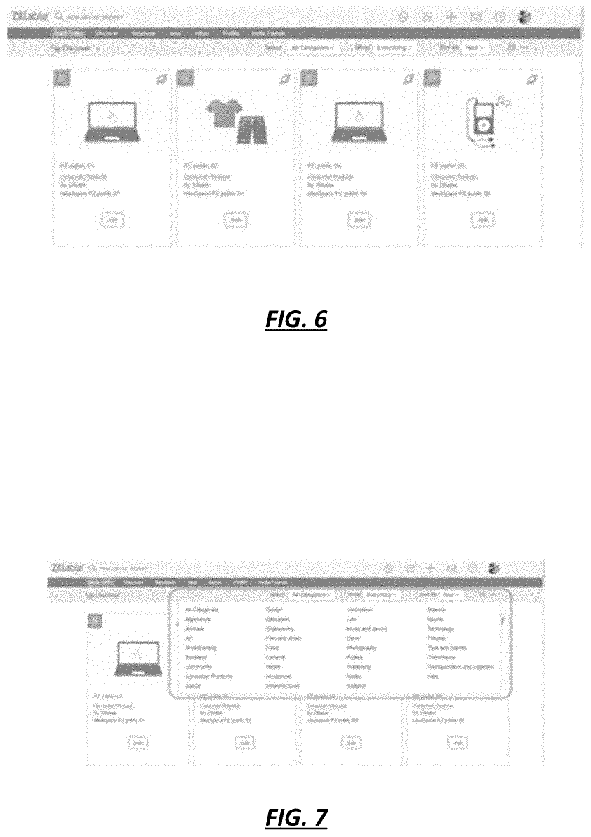

Discover 110 helps inspire and innovate by providing a platform for all content created within a Network 101. As shown in FIG. 6, the Discover feature quickly allows a user to see what others are working on and be inspired to make a own innovation through Discover 110. As shown in FIG. 7, a user can choose to show everything on Discover 110, or filter the content by category and type, e.g. Spaces 102, Ideas 122, Publications 124, Polls 128, Boards 102, Challenges 130, and Inventions.

Discover 110 provides a platform for all the Spaces 102, Boards, Notes, Tasks, Ideas, Documents, Articles, Challenges, Inventions, and Polls within a Network. Quickly see what others are working on and be inspired to make a own innovation through Discover. Discover is uniquely tailored for each network member, depending on access and permission levels. Content and Spaces 102 that a user view on a Discover may not be the same as another member's Discover experience. This is because a user can see A private content and private content that is SHARED WITH a user. Other network members will only see private content when it is directly shared with them.

Notes 114 are reminders to a user or a team. Organized into private or shared Books, a note 114 is a useful tool to keep track of the things a user need to remember. Books help a user keep a Notes and Bookmarks organized (see, below). A user can store important files and documents in Books, and retrieve these anytime, anywhere, from a the collaboration and knowledge management system account. All files and documents in a Books are date- and time-stamped. A user can set Books as Private, or for a eyes only, or Shared, to allow other network members to view the contents within a Book. Notes 114 have many uses. For example, a favorite link a user wants to read up on later can be saved as a note. Have a thought about something useful but not really sure how to formulate the Idea yet? Create a note and come back to it later. Notes 114 provide an unlimited number of snippets of thoughts and ideas and just about anything a user want to tuck away for later.

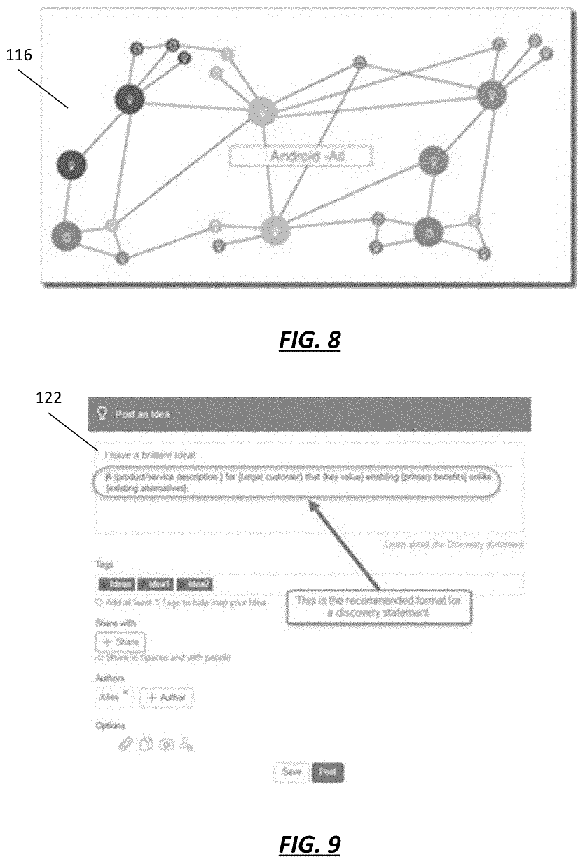

As shown in FIG. 8, maps 116 are a personal GPS, helping a user connect the dots between ideas, papers, and people. Maps 116 provide a powerful graphic canvas to translate a team's minds, skills, and Boards 104 into visual pictures of connected minds, shared skills, and linked workflows. Mapping works like a brain's neural network, allowing a user to understand information and form insights faster and better. Content-based connections help a user visualize what a network members are thinking. These connections may be used to collaborate on areas of mutual interest to network members, or as a springboard for ideas. Sharing ideas with other like-minded individuals helps it grow and develop. The map 116 helps a user find those individuals. The map 116 contains two things, namely, Nodes and Edges. The former represents People, Ideas, or Papers, and the latter represent the connecting lines or relationships between those Nodes. The relationships between Nodes, as displayed on the Map 116, are based on tags that users set on their Ideas and Papers. A user may set Tags on a Ideas and Papers so that these relationships can automatically be set by the system.

Map 116 helps a user visualize all Boards 102 that a user has interacted with and how they are related. The Map 116 helps connect the dots between ideas, papers, solutions, and people. Content-based connections help a user and colleagues visualize what members in a network are thinking and doing. Use these connections to collaborate with each other or as a springboard towards better ideas. With Map 116, a user can find like-minded individuals who share a ideas and a user can bounce around these ideas with each other to improve them further. A user may search for content to add to the Map 116 using a Map Search feature. Notes 114 may be added to a map. The map may be manually edited to connect or isolate nodes.

The collaboration and knowledge management system provides for data retention policies 118 within an organization are a set of guidelines that describes which data will be archived, how long it will be kept, and other factors concerning data retention. The objectives of a data retention policy 118 are to keep important information for future use or reference, to organize information so it can be searched and accessed at a later date, and to dispose of information that is no longer needed.

Compliance Export is built for organizations that do business in regulated industries or have the legal obligation to archive data for compliance purposes. Using Compliance Export, network owners and administrators can access their entire the collaboration and knowledge management system Network data history, including private Space 102 data and direct messages. Compliance Data Retention overrides network-wide, per-Space 102 policy settings. Legal hold is a process that a Network Administrator can enable to preserve all forms of relevant information when litigation is reasonably anticipated. A legal hold be can be enabled by a Network Administrator either network-wide or for specific members of a network as a result of current or anticipated litigation, audit, government investigation, or any similar matter to avoid evidence spoliation. If a Legal Hold is initiated for the entire network, all members of the network will receive a notification of the new network status. If the Legal Hold is targeted for a specific member of the network, only that member receives the Notification.

A task is 120 work or function that needs to be completed within a given time. Anyone within a network can assign tasks to anybody. Tasks 120 may be divided between two or more individual members. Tasks can be created directly from the Content Creation menu. A Note, Update, or Comment may be converted to a task at any time, and vice-versa. To get a Task 120 moving forward, a user may assign a Task card to someone on a team. A user can do this either during or after a user creates the Task 120. A user may also assign resources upon creating the task 120, or add resources later. All members on a Task 120 may add additional resources to the task. A file, priority and/or reminder may be attached to an existing Task.

An Idea 122 can be a thought, something new a user just created, or a shout out about a new development. A user can choose to post an Idea 122 to one or more spaces 102 and start collaborating with other innovators. As shown in FIG. 9, posting a new idea 122 enables a user to claim a stake as the first to come up with the idea (i.e., for Intellectual protection). Ideas can be rated using a 1-5 rating and feedback left about how an idea was rated.

In the collaboration and knowledge management system 100, Publications 124 may be documents that users upload (e.g., PDF files); and Articles that users type and publish directly from within the collaboration and knowledge management system itself 100. Files uploaded to the collaboration and knowledge management system 100, whether attached to a Note 114, Idea 122, Task 120, etc., form part of Publications 124. When a new document is uploaded there are several steps that are performed. The first is to generate the set of words in the new document. Extract the text from the PDF or Word document that was just uploaded. Language detection may be performed and a term index built. A list of stopwords for each language may be built for RAKE multiple language support that allows an administrator to configure how many words to consider in a phrase and how many characters to consider in a word.

Once a user upload a Publication 124, a user can choose to share it with anyone or within the network or any Space 102. Publications 124 may be a central document repository that a user can retrieve later and never worry about losing files and important work again.

Content Creation tools 126 (e.g., zDoc) allow a user to write an article from within the collaboration and knowledge management system. Of course, the audience for an article may be limited to network members or whomever a user want to share the article with, whether a space 102, group, or individual members. As with all other types of content on the collaboration and knowledge management system, a user can attach files and references to a articles. These are then treated as part of a Publications. A Publication is whatever a user chooses it to be—from an article to a spec sheet to an eBook.

Collaborative documents (zDoc) 126 Bring new life to documents. The collaborative documents provide for more than just word processing, but add diagrams, tasks 120, tables, images, annotations, comments, and more to the document and tell the entire story in one place, together. zDoc brings together a myriad of tools, such as messaging, files, tasks, polls, checklists and more to help teams collaborate on a living document in real time. Collaborators on a zDoc can all work at the same time and see every action. Annotations are posted notes or comments to specific areas of a zDoc for other collaborators. Once annotations are triggered, they appear to the right of the zDoc. Collaborators can turn on an annotations slide out through more options. Annotations are not carried over to *.pdf or *.Docx. Comments are the main messaging component of a zDoc. Initiated through more options, comments help teams communicate in real time. Comments are not carried over to *.pdf or *.Docx. Collaborators can choose to review different revisions of a zDoc in version history. This allows for zDoc members to quickly click through and review all changes to the zDoc.

A Poll 128 in the collaboration and knowledge management system 100 enables other users to vote on any content in the collaboration and knowledge management system 100. A question may be posed with answers a user want a audience to vote on.

Challenges 130 are a cost-free and perk-free way of increasing employee engagement and motivating employees to innovate for business success. Challenges 130 are essentially a solutions crowd-sourcing tool designed to help businesses engage, motivate, and inspire employees to solve problems and propose viable solutions to meet internal and external challenges, needs and demands. Challenges 130 may be used to pose a question; engage and motivate employees, partners and customers; seek ideas and solutions; or encourage collaboration and cooperation. Challenges 130 may be liked, shared, edited and duplicated throughout a Network or Networks.

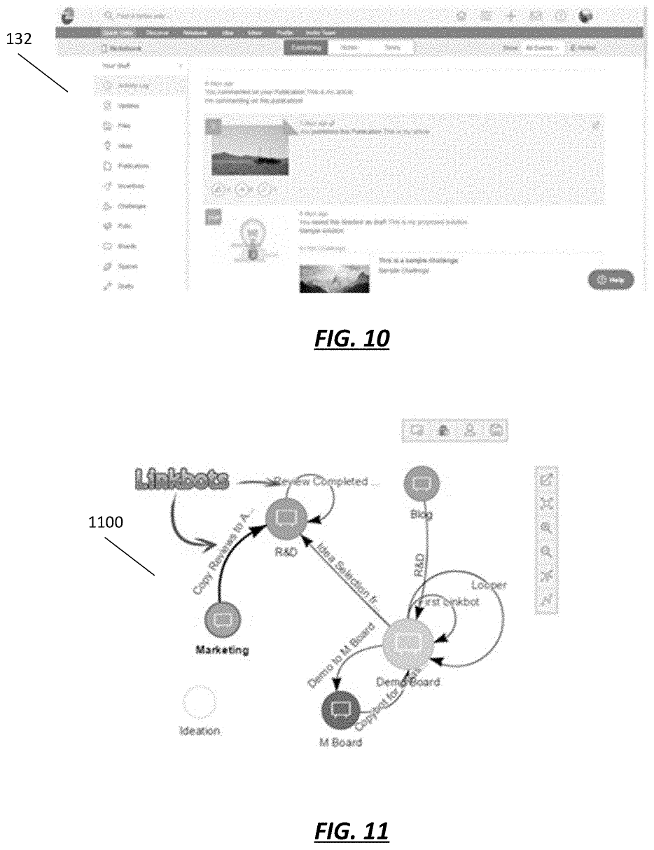

A Notebook 132 is the basis for interactions in a user's Network 101 and Spaces 102. It allows a user to keep track of important items, take notes and create all types of documents while gathering feedback from members of a Network 101. It is an electronic storage bin that can hold any type of data. As show in FIG. 10, the Notebook 132 may be divided into two panes. The leftmost pane, or the Preview pane, presents the available content categories in the Notebook 132 and the right pane, or the Work pane, is where a user work on the specific category item on the left. In most cases, a user can interact directly with items in the Preview pane. For instance, editing a note or adding a comment to a file. The Notebook 132 may be used to quickly interact with a content and those that a user have bookmarked regardless of what Space 102 they belong to.

Gamification

The collaboration and knowledge management system 100 uses gamification elements to promote collaboration and innovation using game-design elements and game principles in a non-game context. zScore is a numeric value used to help evaluate the value of content on a network. zScore is based on social activity and like content connectivity. Every time a network member Likes, Follows, Comments, Shares, or in some cases Forks content, the value of that specific content rises. zScore captures this increase in value. A user can raise a content's zScore proactively by asking network members to rate, comment, or interact with the content personally. There are many strategies a user can use to raise the value of a content. One way is to share it with more Spaces 102 so more network members can see, rate, and comment on a content. Being a own champion is important for people to like a content. A user may personally invite other network members to rate and comment on a content. Every time a content gets any kind of social interaction, the value of its zScore goes up. To sum up, marketing and selling a content boosts zScores.

Members gain zCoins based on their engagement with the rest of a network. A variety of social activities, introducing new content, and their general activities and contributions to a network earn active users points for use in a Shop. The Network administrator controls how these elements intertwine within a network. Use gamification as a means to motivate a network and to facilitate a healthy system of engagement and reward based on desired network usage behavior. zCoin is a closed virtual currency for the collaboration and knowledge management system with no connections to the real world economy. By interacting and engaging within a Network, a user can gain zCoins. For example, any of the activities may gain zCoins for a user and zCoins may be used to virtually shop on the network 101.

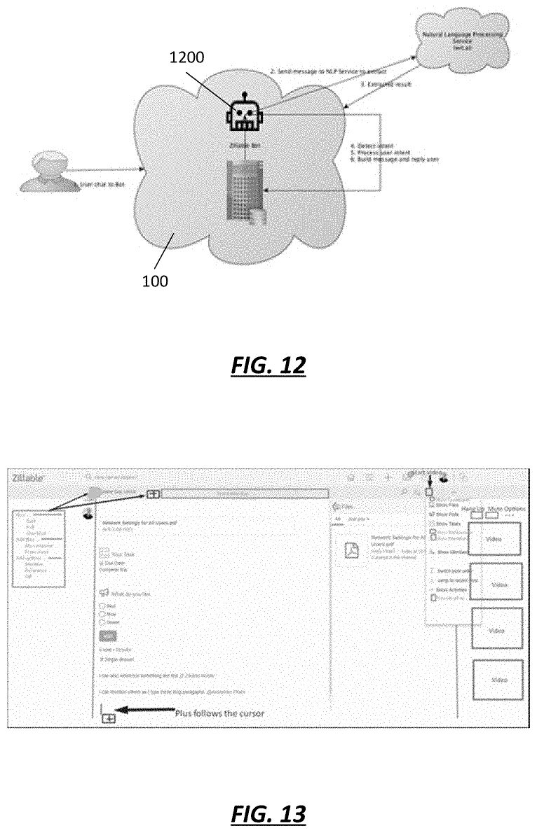

FIGS. 11-12 illustrate example automation tools. A workflow studio tool 1100 to enable users to quickly set up a work network. Using a drag-and-drop method, a user can build a workflow with ease. There is no more distraction, you can view the whole workflow while creating Space, Boards, and connect them using our smart bots. Using workflow studio, a user can create, test, and deploy customized automated workflows using the built-in team apps such as Spaces 102, Boards 104, and Bots 1200. An example Bot 1200 is shown in FIG. 12. The bot 120 interacts with users to perform tasks on the collaboration and knowledge management system 100. Users can chat directly with the bot; mention the bot at any channel, direct message the bot or comment to the bot.

FIG. 13 illustrates an online document collaboration user interface used by content creation 126. The online document collaboration interacts with all content in the knowledge management system 100, including Tasks 120, Notes 114, and Polls 128. The online document collaboration enables two or more users to type and work on a document at the same time, with real-time collaboration, input and changes. Sharing and social functions, such as Mentions, References, and GIFs may be embedded in the online document.

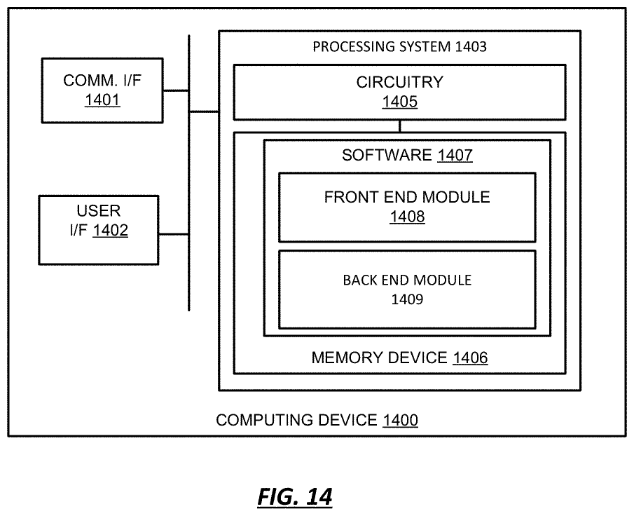

FIG. 14 illustrates a computing device 1400. Computing device 1400 can include computer(s), processor(s), wireless devices, portable devices, and/or display devices, and/or combinations thereof, although alternative configurations are also included. Computing device 1400 comprises communication interface 1401, user interface 1402, and processing system 1403. Processing system 1403 is linked to communication interface 1401 and user interface 1402. Processing system 1403 includes processing circuitry 1405 and memory device 1406 that stores operating software 1407. Computing device 1400 may include other well-known components such as a battery and enclosure that are not shown for clarity. Computing device 1400 may be a telephone, computer, e-book reader, mobile Internet appliance, media player, game console, wireless network interface card, or some other processing device—including combinations thereof.

Communication interface 1401 comprises components that communicate over communication links, such as network cards, ports, RF transceivers, processing circuitry and software, or some other communication devices. Communication interface 1401 may be configured to communicate over metallic, wireless, or optical links. Communication interface 1401 may be configured to use TDM, IP, Ethernet, optical networking, wireless protocols, communication signaling, or some other communication format—including combinations thereof.

User interface 1402 comprises components that interact with a user to receive user inputs and to present media and/or information. User interface 1402 may include a speaker, microphone, buttons, lights, display screen, touch screen, touch pad, scroll wheel, communication port, or some other user input/output apparatus—including combinations thereof. User interface 1402 may be omitted in some examples.

Processing circuitry 1405 comprises microprocessor and other circuitry that retrieves and executes operating software 1407 from memory device 1406. Memory device 1406 comprises a non-transitory storage medium, such as a disk drive, flash drive, data storage circuitry, or some other memory apparatus. Processing circuitry 1405 is typically mounted on a circuit board that may also hold memory device 1406 and portions of communication interface 1401 and user interface 1402. Operating software 1407 comprises computer programs, firmware, or some other form of machine-readable processing instructions.

Operating software 1407 includes front end module 1408 and back end module 1409. Operating software 1407 may further include an operating system, utilities, drivers, network interfaces, applications, or some other type of software. When executed by processing circuitry 1405, operating software 1407 directs processing system 1403 to operate computing device 1400 as described herein.

In particular, front end module 1408 can direct processing system 1403 to receive disclosures and route them into the patent aggregation process, and back end module 1409 can route the disclosure through the patenting process.

Front end module 1408 may be part of the operating system of computing device 1400, the application installed on computing device 1400, a different application on computing device 1400, or some other independent software component. Though shown separately, back end module 1409 may be incorporated into front end module 1408.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A non-transitory computer readable medium having instructions stored thereon for operating a computing device, wherein the instructions, when executed by the computing device, direct the computing device to:
define a network having a plurality of collaboration tools;
index content so it is discoverable by each of the collaboration tools;
provide for collaborative content creation; and
provide for automation of tasks.

2. The non-transitory computer readable medium of claim 1, further comprising instructions to direct the computing device to:
define a Space as a collaboration sandbox wherein users collaborate together; and
display, within a Space user interface, Channel and Explore areas, wherein the Channel area contains posts and updates on the Space and wherein the Explore area is search facility for content within the Space.

3. The non-transitory computer readable medium of claim 2, further comprising instructions to direct the computing device to define a Board that manages aspects of the Space, include Lists with Cards that represent users and content within the Space.

4. The non-transitory computer readable medium of claim 2, further comprising instructions to:
present a map that visualizes the connectivity of content of the Board using nodes and edges, wherein the nodes present content or people in the Spacer, and wherein the edges represent the relationships between the nodes.

5. The non-transitory computer readable medium of claim 4, further comprising instructions to display relationships between plural Boards associated with a user using the map.

6. The non-transitory computer readable medium of claim 1, further comprising instructions to:
receive an uploaded document;
scan the uploaded document to generate a set of words associated with the uploaded document; and
extract text from the uploaded document to build a term index.

7. The non-transitory computer readable medium of claim 1, further comprising instructions to:
display a document collaboration user interface wherein plural users collaboratively edit a document;
provide tools with the document collaboration user interface for messaging between the plural users, for creating tasks, for creating polls, for creating checklists; and
display annotations to the document in a comments area visible to the plural users.

8. The non-transitory computer readable medium of claim 7, further comprising instructions to maintain a version history of the document.

9. The non-transitory computer readable medium of claim 1, further comprising instructions to present a workflow studio tool that provides a drag-and-drop user interface to build an automated workflow.

10. The non-transitory computer readable medium of claim 1, further comprising instructions to display an automated Bot that interacts with users to perform tasks by receiving inputs from a user that cause the Bot to perform automated actions.

11. A computer implemented method for providing a collaboration and knowledge management system, comprising:
defining a network having a plurality of collaboration tools;
indexing content so it is discoverable by each of the collaboration tools;
providing for collaborative content creation in a user interface; and
providing for automation of tasks.

12. The computer implemented method of claim 11, further comprising:
defining a Space as a collaboration sandbox wherein users collaborate together; and
displaying, within a Space user interface, Channel and Explore areas, wherein the Channel area contains posts and updates on the Space and wherein the Explore area is search facility for content within the Space.

13. The computer implemented method of claim 12, further comprising defining a Board that manages aspects of the Space, include Lists with Cards that represent users and content within the Space.

14. The computer implemented method of claim 12, further comprising:
presenting a map that visualizes the connectivity of content of the Board using nodes and edges, wherein the nodes present content or people in the Spacer, and wherein the edges represent the relationships between the nodes.

15. The computer implemented method of claim 14, further comprising displaying relationships between plural Boards associated with a user using the map.

16. The computer implemented method of claim 11, further comprising:
receiving an uploaded document;
scanning the uploaded document to generate a set of words associated with the uploaded document; and
extracting text from the uploaded document to build a term index.

17. The computer implemented method of claim 11, further comprising:
displaying a document collaboration user interface wherein plural users collaboratively edit a document;
providing tools with the document collaboration user interface for messaging between the plural users, for creating tasks, for creating polls, for creating checklists; and
displaying annotations to the document in a comments area visible to the plural users.

18. The computer implemented method of claim 17, further comprising maintaining a version history of the document.

19. The computer implemented method of claim 11, further comprising presenting a workflow studio tool that provides a drag-and-drop user interface to build an automated workflow.

20. The computer implemented method of claim 11, further comprising display an automated Bot that interacts with users to perform tasks by receiving inputs from a user that cause the Bot to perform automated actions.
